(19) United States
(12) Patent Application Publication
(10) Pub. No.: US 2012/0159127 A1
(43) Pub. Date: Jun. 21, 2012

(54) SECURITY SANDBOX

(75) Inventor: Jeremiah Spradlin, Woodinville, WA (US)

(73) Assignee: MICROSOFT CORPORATION, Redmond, WA (US)

(21) Appl. No.: 12/970,927

(22) Filed: Dec. 16, 2010

(51) Int. Cl. G06F 9/30

(52) U.S. Cl. 712/208; 712/220; 712/E09.016; 712/E09.028

(57) ABSTRACT

Different instruction sets are provided for different units of execution such as threads, processes, and execution contexts. Execution units may be associated with instruction sets. The instruction sets may have mutually exclusive opcodes, meaning an opcode in one instruction set is not included in any other instruction set. When executing a given execution unit, the processor only allows execution of instructions in the instruction set that corresponds to the current execution unit. A failure occurs if the execution unit attempts to directly execute an instruction in another instruction set.

### BACKGROUND

Modern operating systems are generally composed of at least two primary security layers. One security layer (e.g., an application layer) has lesser privileges than the other higher privileged layer (e.g., a kernel layer). The kernel layer has a higher privilege level because it interfaces with the underlying hardware, either directly, or in the case of virtualization, with a hypervisor. Many processors provide more than two privilege levels, which some operating systems may make use of. For example, some operating systems may have device drivers executing between an application layer and a kernel layer.

With prior operating systems and CPUs (central processing units), the same processor instruction set has been available for use at all layers. That is, there is one global set of opcodes (operation codes). For instance, a process executing at an application level would use some of the same machine instructions used by a process executing at a higher privilege level, such as a kernel. Semantic differentiation between the layers has been in the software executing on the processor, and to some extent the hardware, which will restrict or deny access to specific functionality based upon the current privilege level.

A problem with this approach, however, is that a rogue application or hostile code can elevate the privilege level of the corresponding current execution context, and thereby gain access to the higher-privilege resources within the operating system or computer. Consider, for example, when a buffer overflow condition is exploited by malicious code. It becomes difficult to have awareness, at a low level, of whether affected or relevant code in the overflow area should or should not be allowed to execute. At high levels of abstraction it might be clear that some code is unauthorized, but at a low level of abstraction, such as at the CPU level, it is impossible to tell if code is authorized. Generally, there has been no way to know with certainty that code outside the space of the malicious code (e.g., privileged code in the overrun space) is under the control of a non-privileged process.

Previous approaches have attempted to prevent this condition by hardening the application layer so that malicious code cannot be run on a system in the first place. For instance, trusted code systems and code scanning have been used, not to mention sophisticated operating system security schemes. Alternatively, there are fuzzy solutions that try to non-deterministically decide if malicious code is running on the system by looking at the behavior of the system and comparing the behavior to some heuristic. For example, certain call sequence patterns may be suspect. However, there have been no solutions that can deterministically evaluate current code executing within the kernel to decide if it is valid or malicious.

Techniques related to using incompatible instruction sets to isolate or “sandbox” executable code are discussed below.

### SUMMARY

The following summary is included only to introduce some concepts discussed in the Detailed Description below. This summary is not comprehensive and is not intended to delineate the scope of the claimed subject matter, which is set forth by the claims presented at the end.

Embodiments herein relate to the use of different instruction sets for different units of execution such as threads, processes, protection domains, and the like. Execution units may be associated with instruction sets. The instruction sets may have mutually exclusive opcodes, meaning an opcode in one instruction set is not included in any other instruction set. When executing a given execution unit, the processor only allows execution of instructions in the instruction set that corresponds to the current execution unit. A failure occurs if the execution unit attempts to directly execute an instruction in another instruction set.

Many of the attendant features will be explained below with reference to the following detailed description considered in connection with the accompanying drawings.

### BRIEF DESCRIPTION OF THE DRAWINGS

The present description will be better understood from the following detailed description read in light of the accompanying drawings, wherein like reference numerals are used to designate like parts in the accompanying description.

FIG. 1 shows a processor.

FIG. 2 shows instruction sets in association with protection rings, respectively.

FIG. 3 shows example instruction sets.

FIG. 4 shows a process for fetching and executing instructions.

FIG. 5 shows execution units executing in different protection rings.

FIG. 6 shows a messaging system.

FIG. 7 shows IPC messaging.

### DETAILED DESCRIPTION

As mentioned in the Background, in the field of computer security there have been many attempts to solve the problem of preventing malicious code from executing. Prior solutions have fallen into two general categories: static protection and dynamic detection. Static protection solutions have aimed to ensure that only valid code is executed. An example of static protection is the Media Foundation Protected Media Path (PMP)™, which only loads binaries that are cryptographically signed. Dynamic protection solutions have aimed to look at the dynamic behavior of a system to identify security breaches. An example of dynamic detection is malware detection code, which observes the behavior of a machine and attempts to identify the emergence of any irregular behavior patterns, such as new ports being opened after web page requests, etc. Dynamic and static approaches have even been combined. However, neither approach, alone or in combination with the other, has been able to guarantee isolation of different code bases with different privilege levels. In prior approaches, a breach in privilege protection leads to the ability to execute unauthorized privileged code.

Techniques described herein allow code isolation to occur by providing divergent and incompatible instruction sets on a same computer, operating system, and/or application platform. These techniques allow code that interacts with outside or untrusted entities to be effectively sandboxed by allowing execution units to directly execute instructions from only one instruction set (as used herein, an execution unit will refer to a thread, process, hierarchical protection domain (e.g., protection ring), or equivalent, where a process provides a virtual execution environment for threads). If a particular process or thread or ring (i.e., an execution unit) is breached, it will be breached with the sandboxed instruction set, which is explicitly associated with the breached execution unit and consequently is unable to execute on the machine any instructions in another—perhaps more capable—instruction set. In effect, code that is associated with and runs one instruction set only has access to the functionality and resources available through that instruction set. If the instruction set is limited and does not allow access to various sensitive or privileged resources, a process running with that instruction set does not have the ability to execute certain privileged instructions. Conceptually, the processor may be thought of as speaking two different languages; execution units associated with one state (and only those execution units) can only speak that state's language.

Explanation will now proceed with discussion of a generic processor, followed by a discussion of how instruction sets are associated with execution units. Example instruction sets will then be discussed. Description of how instructions are decoded will be provided, followed by discussion of message passing between processes or contexts that have different instruction sets.

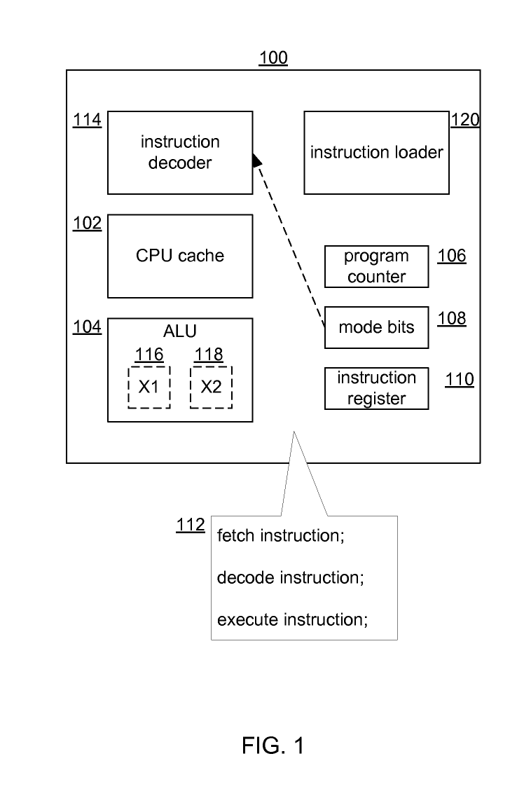

FIG. 1 shows a generic processor 100. The processor may be of any type, for instance a RISC (reduced instruction set computer) or CISC (complex instruction set computer) processor. Moreover, the processor 100 may implement instructions directly or indirectly using microcode. The processor 100 has various known components such as a CPU cache 102, an arithmetic logic unit (ALU) 104, and a program counter 106. Mode bits 108 indicate a current mode at which the processor 100 is operating, and consequently, which instruction set is active. In one embodiment, the mode may correspond with a privilege level (e.g., a ring), but it is sufficient that the processor 100 have means for associating instruction sets with modes. An instruction register 110 holds a current instruction being executed. A typical instruction handling cycle 112 may involve fetching an instruction from CPU cache 102 and storing it in the instruction register 110. An instruction decoder 114 then decodes the opcode (operation code) of the instruction in the instruction register 110, possibly also manipulating registers and memory to load addresses specified by the instruction in the instruction register 110. The instruction is the executed by the ALU 104.

In one embodiment, the ALU 104 implements two different instruction sets; instruction set X1 116 and instruction set X2 118. From the point of view of code executing on the processor 100, the ALU 104 is transparent. The processor 100 has a “contract” with executing code that invocation of a given instruction will result in the processor 100 responding by performing a corresponding operation of some type (e.g., adding registers, negating a register, etc.). However, the convention or protocol of processor 100 is that only instructions in an instruction set corresponding to the current mode (per mode bits 108) will be executed.

In one embodiment, instruction set isolation is implicitly provided in the instruction decoding process. The instruction decoder 114 is linked with the mode bits 108. That is, the logic of the instruction decoder 114 is informed by the content of mode bits 108. Whether the processor will recognize as valid instructions in instruction set X1 116 or in instruction set X1 118 depends on the current mode indicated in the mode bits 108. Specifically, the instructions that the instruction decoder 114 will recognize depends on the mode bits 108. For example, when the mode bits 108 indicate that the mode is “0”, then the instruction decoder 114 may fail to decode a current instruction and raise an “invalid opcode exception” or the like.

In another embodiment, instruction set isolation is provided in the ALU 104. The ALU 104 looks to the mode bits 108 to determine whether an instruction request should be granted. In yet another embodiment, an instruction loader 120 may, when loading an instruction into the instruction register 110, look at bits in the instruction that indicate which instruction set the instruction belongs to. The instruction loader 120 may refuse to load an instruction if there is a mismatch between the current mode indicated by the mode bits 108 and the instruction set to which the instruction belongs. It will be appreciated that there are many points in the instruction loading and executing process where instructions can be filtered or limited based on the current mode, with the effect that one set of instructions is available in one mode, and another mutually exclusive set of instructions is available in another mode.

While mode bits are one way to handle different instruction sets, any register can be used. Moreover, the mode of an instruction set or execution unit is simply a management technique. As instruction sets are generally static and finite in number, the operating system selectively or systematically associates different execution units with different instruction sets. For example, an active process table might have an “instruction set” column with a flag to indicate the instruction sets of different processes. When the operating system begins executing a process in the table, the operating system sets the mode bits according to the mode in the corresponding process table entry.

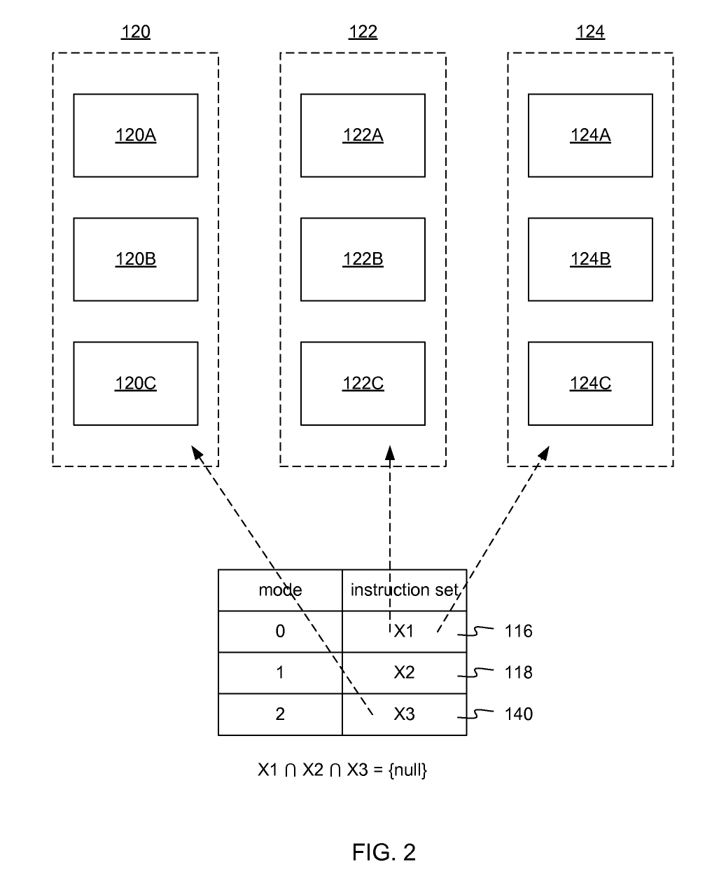

FIG. 2 shows instruction sets X1 116, X2 118, and X3 140, in association with conceptual sandboxes 120, 122, 124. In the embodiment shown in FIG. 2, the processor provides execution isolation by allowing execution units to execute only instructions in their associated instruction sets. For execution units 120A, 120B, 120C in sandbox 120 (for instance, a mode identified in mode bits 108), only instruction set X1 116 is valid. In sandbox 122, execution units 122A, 122B, 122C are allowed to execute only instructions in instruction set X2 118, and execution units 124A, 1248, 124C in sandbox 124 are only allowed to execute instructions in instruction set X3 140. Note that at least two modes or sandboxes and two corresponding instruction sets are needed, but three or more may be used.

In one embodiment, the sandboxes may correspond to hierarchical protection domains or protection rings. In this case, the processor may have two instruction sets, where one instruction set is associated with (and valid for) one protection domain (e.g., ring0) only, and the other instruction set is associated with multiple other protection domains (e.g., instruction set X2 118 is associated with ring1 144 and ring2 146).

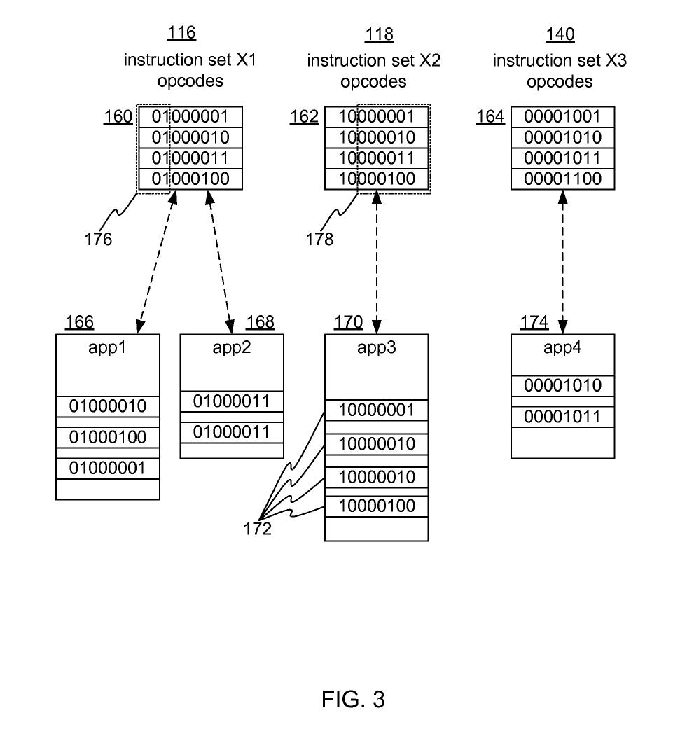

FIG. 3 shows example instruction sets. As is known in the art, a machine instruction consists of an opcode along with other data such as registers, informative bits, and so on. For illustration, FIG. 3 shows only opcodes 160, 162, and 164 of instruction sets X1 116, X2 118, and X3 140, respectively. Each opcode, regardless of its instruction set, is globally unique. That is, the opcode or instruction decoder 114 will decode each opcode uniquely. Moreover, the opcodes 160, 162, and 164 are mutually exclusive. In one embodiment, an opcode (and the instruction it represents) in one instruction set is not found in any other instruction set. For illustration, applications (one or more execution units) are shown that are comprised of instructions from the respective instruction sets. For example, app1 166 and app2 168 have instructions only from instruction set X1 116. Application denoted app3 170 has only instructions from instruction set X2 118 (as shown by the corresponding opcodes 172), and app4 174 has opcodes/instructions only in instruction set X3 140. The operating system tracks which application or execution unit is associated with which mode or instruction set; the instruction sets associated with applications or execution units will depend on runtime conditions when the execution units are loaded and executed by the operating system.

In one embodiment, the instruction sets and opcodes need not be mutually exclusive. Innocuous instructions may be used in the same instructions sets, and the instruction sets may be mutually exclusive only with regard to instructions that present security risks. Moreover, instruction sets may be composed of both instruction subsets (which are also instruction sets) that are mutually exclusive, and subsets of instructions that overlap.

One approach to implementing mutually exclusive opcodes is to have a first bit sequence 176 in each opcode be unique for each instruction set and the same for each instruction in an instruction set (not necessarily the first bits in the instruction, and a bit sequence may be one bit). For example, the first two bits of the opcodes 160 of instruction set X1 116 all contain “01”. Similarly, opcodes 162 have “10” in the first bit sequence, and opcodes 164 have “00” in the first bit sequence. In this embodiment, it may be convenient to also have a second bit sequence 178 in each instruction that uniquely identifies the instruction within its instruction set. This approach may allow two instructions in different instruction sets to both be conveniently implemented using the same circuitry in the ALU 104, but still exist as distinct operations with different opcodes. That is, a first ADD instruction might have opcode “01000001” in instruction set X1 116, and another ADD instruction in instruction set X2 118 might have opcode “10000001”. Although both are technically different instructions with different opcodes, it may be the case that because ADD is deemed to be a benign operation, the functionality may be available in multiple instruction sets. In one embodiment, one application or process may have different sections with code for different instruction sets, and the operating system will, as described below, handle context switching between the execution units using different sets of incompatible instructions.

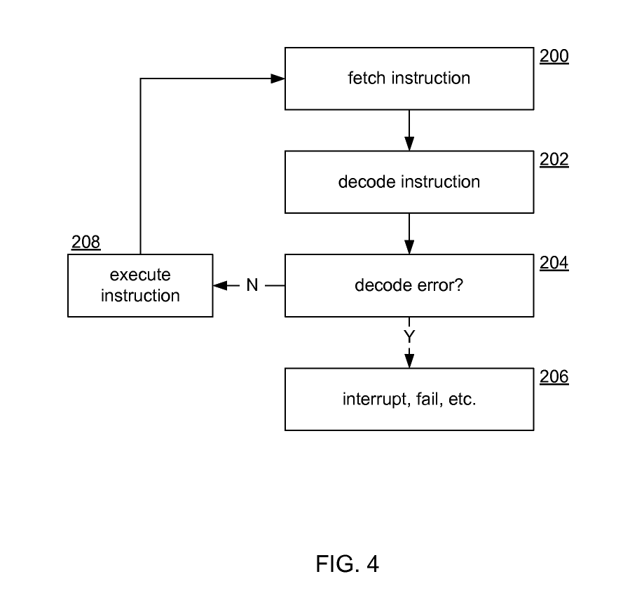

FIG. 4 shows a process for fetching and executing instructions. The process begins at step 200 by fetching a next instruction to be executed. The instruction is then decoded at step 202. As mentioned above, the processor only implements or recognizes instructions with opcodes that correspond to the currently active instruction set. Thus, if at step 204 there is an error decoding the instruction, then some failure measure occurs at step 206. For instance, an interrupt is generated, the current execution context is halted, etc. If the instruction is decoded successfully, then at step 208 the instruction is executed by the processor's ALU or equivalent.

As noted above, there are other ways to allow only instructions of a specific instruction set to execute in a given CPU mode. For example, during the instruction loading process a screening step may be added to check the incoming opcode against a table that associates opcodes with instruction sets (or, operation modes that correspond to the instructions sets). As another example, instruction restriction can be performed when executing an instruction. Even if an instruction is decoded correctly, execution logic in the ALU can test whether the current mode is the correct one for the current instruction.

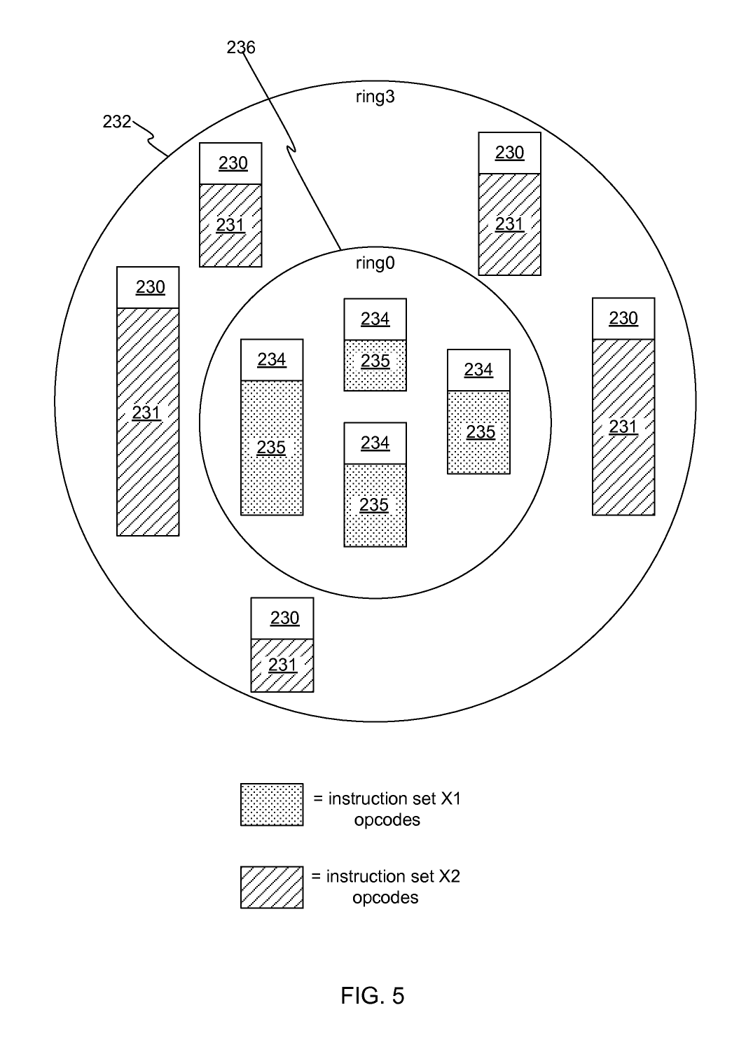

FIG. 5 shows execution units executing in different protection rings. In this embodiment, as above, an execution unit is any unit of execution such as a thread, a process, or the like, or a unit of containment thereof such as a hierarchical protection domain, protection domain, or the like. Execution units 230 are each composed of various instructions 231 from a first instruction set that is valid only for ring3 232 (e.g., X2). The execution units 230 execute at ring3 232. Execution units 234 are each composed of only instructions 235 in another instruction set (e.g., X1) that is valid only for ring0 236, where execution units 234 reside. As the operating system allocates processor execution time among the execution units 230, 234, the operating system, from ring0 236, manages the current protection domain. As the processor executes instructions 231 and instructions 235, only instructions in the current ring's instruction set are actually executable. Even if a rogue execution unit 230 finds a way to elevate its privilege level to ring0 236, it will not be able to exploit the corresponding gain in privilege, because when ring0 is the active protection domain, the instructions 231 of the rogue execution unit 230 will not even be able to execute. In effect, each execution unit 230 is locked down at ring3 232 and cannot execute at least some of the functionality that is inherent in ring0's instruction set.

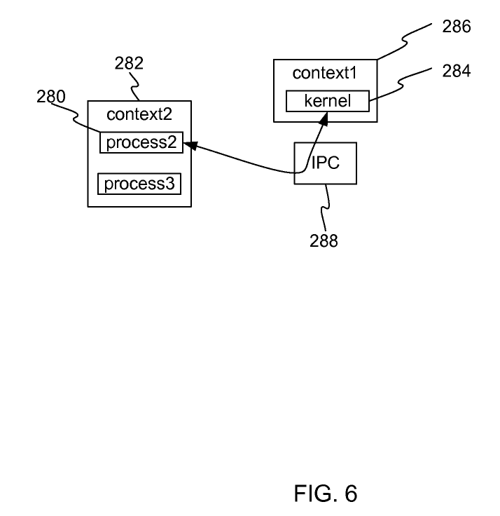

FIG. 6 shows a messaging system. It may be helpful to allow a process (or thread) executing one instruction set to invoke functionality of another process executing another instruction set. For example, if process2 280 is executing in context2 282 with a first instruction set, then the process2 280 may be able to indirectly invoke some external code, for example kernel process 284 executing in context1 286 (and executing a separate instruction set), using an IPC messaging service 288.

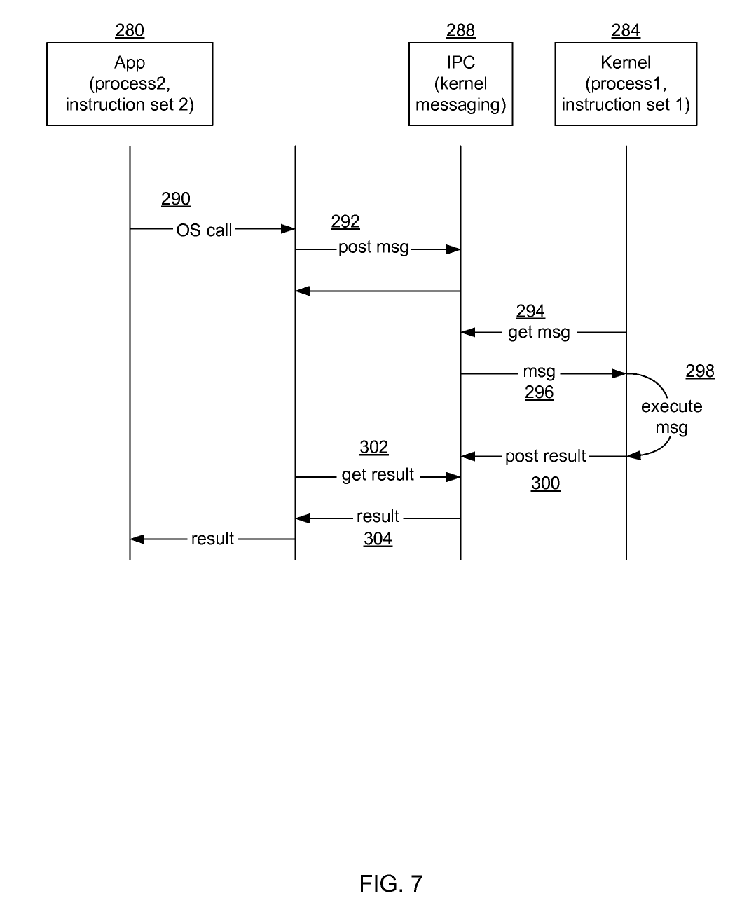

FIG. 7 shows how IPC messaging service 288 intermediates execution between process2 280 and a kernel 284. At step 290, process2 280 invokes an OS (operating system) call. At step 292 the process2 280 posts a corresponding message in a message queue in the IPC messaging service 288. At step 294 the kernel 284 informs the IPC messaging service 288 that it is available for a next message. The IPC messaging service 288 responds at step 296 by popping the message from the queue and passing the message about the OS call to the kernel 284. The kernel 284, at step 298, executes the OS call using the correct instruction set. A result is posted to the IPC messaging service 288 at step 300. At step 302 the IPC messaging service obtains the result and at step 304 passes the result back to the process2 280. Of course, the message passing and or execution at step 298 is only permitted if the process2 280 has appropriate authorization. In another embodiment, IPC messaging is implemented using a shared memory with a lock that allows separate execution units to pass information back and forth between execution contexts. In this embodiment, the kernel or operating system monitors the shared memory and informs execution units when messages are in the shared memory.

With embodiments described above, risky execution contexts or processes such as those which parse HTTP (hypertext transfer protocol) requests can be effectively sandboxed, as in order to breach those processes, only instructions in the HTTP parser's instruction set can be used, and if properly limited, that instruction set may not allow access or manipulation of various system resources. Moreover, an operating system may handle a processor with instruction sets as discussed above by handling loading of binaries that are made up of sections with differing instruction sets, handling context switching between the different instruction sets, and managing the protection domains of the different execution contexts.

### CONCLUSION

Embodiments and features discussed above can be realized in the form of information stored in volatile or non-volatile computer or device readable media. This is deemed to include at least media such as optical storage (e.g., compact-disk read-only memory (CD-ROM)), magnetic media, flash read-only memory (ROM), or any current or future means of storing digital information. The stored information can be in the form of machine executable instructions (e.g., compiled executable binary code), source code, bytecode, or any other information that can be used to enable or configure computing devices to perform the various embodiments discussed above. This is also deemed to include at least volatile memory such as random-access memory (RAM) and/or virtual memory storing information such as central processing unit (CPU) instructions during execution of a program carrying out an embodiment, as well as non-volatile media storing information that allows a program or executable to be loaded and executed. The embodiments and features can be performed on any type of computing device, including portable devices, workstations, servers, mobile wireless devices, and so on.

1. A method of sandboxing executable instructions for execution on a processor, the method comprising:
running the processor, wherein the processor implements a first instruction set and a second instruction set, the first instruction set comprised of first instructions with respective first opcodes, the second instruction set comprised of second instructions with respective second opcodes, and where the first instruction set is associated with and implemented only when the processor is in a first mode, and where the second instruction set is associated with and implemented only when the processor is in a second mode;
executing first execution units and second execution units on the processor, the first execution units each comprising a respective plurality of the first instructions, and the second execution units each comprising a respective plurality of the second instructions; and
at any given time while executing the first and second execution units, when decoding instructions, recognizing only first opcodes as valid instructions while the processor is operating in the first mode, and recognizing only second opcodes as valid instructions while the processor is operating in the second mode.

2. A method according to claim 1, wherein some of the opcodes in the first instruction set are equal to opcodes in the second instruction set.

3. A method according to claim 1, wherein the first opcodes are mutually exclusive of the second opcodes such that each of first opcodes is unequal to each of the second op codes.

4. A method according to claim 3, wherein the instruction set that is currently implemented by the processor changes during execution context switches that change the current execution context.

5. A method according to claim 1, wherein only the first opcodes or the second opcodes are recognized by the processor as valid opcodes at any given time.

6. A method according to claim 5, wherein when the first opcodes are currently recognized by the processor, and when a second opcode is attempted to be executed, a decoder of the processor fails to decode the second opcode.

7. A method according to claim 1, wherein the first mode comprises a first protection domain of the processor, the second mode comprises a second protection domain of the processor, the method further comprising executing an operating system comprised of instructions in the first instruction set and executing at the first protection domain, the first privilege level comprising a kernel protection domain.

8. A method according to claim 1, further comprising, when an execution unit running in the second mode has a call to a kernel of the operating system, posting a corresponding message that is passed to the kernel by an inter-process communication (IPC) messaging service, the kernel executing code corresponding to the call when a corresponding message is received from the IPC messaging service, and a corresponding result being passed from the IPC messaging service to the execution unit running in the second mode.

9. A processor comprising:
a first instruction set, the first instruction set comprising a first plurality of machine instructions implemented by the processor, wherein code loaded into the processor comprising instructions in the first plurality of machine instructions can be decoded and executed by the processor only if the code is part of an execution unit that is associated with the first instruction set;
a second instruction set, the second instruction set comprising a second plurality of machine instructions directly implemented by the processor, wherein code loaded into the processor comprising instructions in the second instruction set can be decoded and executed by the processor only if the code is part of an execution unit associated with the second instruction set; and
wherein the first instruction set and the second instruction set are mutually exclusive such that the first instruction set has no instructions of the second instruction set, and the second instruction set has no instructions of the first instruction set.

10. A processor according to claim 9, wherein the processor only recognizes instructions in the first instruction set as valid instructions when a mode setting in the processor is currently set to a first value corresponding to the first instruction set.

11. A processor according to claim 10, wherein the processor only recognizes instructions in the second instruction set as valid instructions when the mode setting in the processor is currently set to a second value corresponding to the second instruction set.

12. A processor according to claim 11, wherein whenever an execution unit is executing on the processor while the mode setting has the second value attempts to execute a given machine instruction in the first instruction set, the processor does not execute the given machine instruction.

13. A processor according to claim 12, wherein the processor does not recognize an opcode of the given machine instruction and in response generates a processor interrupt.

14. A processor according to claim 8, wherein a first machine instruction in the first instruction set performs a same function as a second machine instruction in the second instruction set, and the first instruction and the second instruction have different opcodes.

15. A processor according to claim 8, the processor further comprising a messaging service that intermediates messages between execution units executing with the first mode value and execution units executing with the second mode value, the messaging service allowing an execution unit executing with the second mode value to have a machine instruction associated with the first mode value executed by an execution unit executing with the first mode value.

16. A processor according to claim 15, wherein first and second modes comprise first and second processor protection domains, respectively, and the processor does not allow execution units with the second protection domain to be elevated to the first protection domain.

17. A method performed by a processor that provides at least a first mode and a second mode, the method comprising:
executing execution units associated with the first mode;
executing execution units associated with the second mode;
while any execution unit is currently executing while the processor is set to the first mode, allowing only instructions in a first set of instructions to be executed; and
while any execution unit is executing and while the processor is set to the second mode, allowing only instructions in a second set of instructions to execute, the second set of instructions not including any instructions of the first set of instructions.

18. A method according to claim 17, wherein the first set of instructions does not include any instructions of the second set of instructions.

19. A method according to claim 17, wherein the first set of instructions comprises first opcodes, the second set of instructions comprises second opcodes, and the first opcodes are mutually exclusive of the second set of opcodes.

20. A method according to claim 17, wherein each opcode comprises a first sequence of bits and a second sequence of bits, wherein each first opcode has a corresponding second opcode with a same bitstring in the second sequence of bits, wherein the first opcodes all have a same bitstring in the first sequence of bits.
